(19) United States
(12) Patent Application Publication
(10) Pub. No.: US 2013/0192005 A1
(43) Pub. Date: Aug. 1, 2013

(54) Wrench

(71) Applicant: Marc Christenson, Glenview, IL (US)

(72) Inventor: Marc Christenson, Glenview, IL (US)

(73) Assignee: D.S. Arms, Incorporated, Lake Barrington, IL (US)

(21) Appl. No.: 13/743,318

(22) Filed: Jan. 16, 2013

Related U.S. Application Data
(60) Provisional application No. 61/587,117, filed on Jan. 16, 2012.

(51) Int. Cl. B25F 1/00

(52) U.S. Cl. CPC B25F 1/006
USPC 7/138

(57) ABSTRACT

An improved wrench for use with a firearm, such as an AR15/M$ firearm, which provides wrenches adapted for connection to corresponding fasteners and element on the firearm which require servicing for maintaining the firearm and provide added advantages of torque and leverage for the user.

### PRIORITY CLAIM

Applicant claims priority from provisional application No. 61/587,117 filed 16 Jan. 2012.

### SPECIFICATION

### FIELD OF THE INVENTION

This invention relates to a combination wrench for use by a user of a rifle-like firearm, particularly an AR15/M4 firearm, to service his weapon in the field, and, additionally applicant discloses a tomahawk device which may be used alone or in association with the wrench.

Presently, users of such firearms have needed to bring wrenches and screw drivers for maintaining and servicing a weapon as well as a cutting edge for various cutting purposes. These armorer tools are of no use if left in the shop and not available in the field. This improved wrench lightens the load and makes life easier for the outdoorsman by providing a convenient combination tool that makes more operations possible with less weight by making more use of combinations of tools and the handle and, on top of that efficiency improvement, provides for cutting edges and a pick. The wrench design has corresponding apertures for servicing and maintaining fasteners and serviceable element on the weapon, as well as having cutting heads which enable the outdoorsman to trench, to climb and make holes in ice or any other material with either the cutting head or the pick head of the improved wrench.

With this one tool providing solutions for at least eight operations, the user leaves in the shop at least seven tools he or she would have otherwise need. The improved wrench may be about 14-inches long and has service connections which correspond to most AR15/M4 (and similar weapons) fasteners and serviceable devices, sized to the original equipment manufacture's specifications. The Improved Wrench includes the following tools in a single piece of steel:
1. Tool for a collapsible Stock;
2. Tool for a Barrel Nut;
3. Tool for 0.5 inch square for torque wrench;
4. Slot for a fixed stock;
5. Slot for a flashier;
6. Hatchet cutting tool; and,
7. Pick cutting tool.

### BACKGROUND OF THE INVENTION

For many years, outdoorsmen have sought ways to aggregate tools in a manner that results in fewer tools with more functionality. The Improved Wrench is such a tool. An outdoorsman would have a hatchet, but he would waste the opportunity to use the potential of the long handle to combine with tools that might require torque when used. This is certainly true for AR15/M4 users who need torque to disassemble parts of their rifles. Moreover, the outdoorsman benefits from having a shape that is easily recognizable. He can easily learn the place of each tool. He will then be able deftly to go to that tool in the dark or when he is looking elsewhere. The end result is much higher efficiency in use.

### OBJECTS OF THE INVENTION

The following are objectives of the improved wrench invention:
1. To provide an improved wrench for the AR15/M4 collapsible stock or the like;
2. To provide an improved wrench for the AR/15/M4 barrel nut or the like;
3. To provide an improved wrench usable as a square torque tool;
4. To provide an improved wrench with a slot for AR15 fixed stock or the like;
5. To provide an improved wrench with a slot for AR15/M4 flash hider or the like;
6. To provide an improved wrench with a hatch blade tool; and
7. To provide an improved wrench with a pick blade.

### SUMMARY OF THE INVENTION

The invention consists of a improved wrench for use by an outdoorsman with an AR15/M4 or similar rifle who needs typical wrenches for maintaining the rifle , as well as a hatchet and pick available for use by an outdoorsman in the field or on a hunting trip. Moreover, the advantage of the improved wench is to provide torque and leverage which is not otherwise otherwise available in the field. The improved wrench embodying the present invention preferably is made of about 0.25 inch high carbon steel. The improved wrench is designed to provide more steel and more leverage where material and leverage are essential, particularly in, the case of a barrel bolt tool, a collapsible stock tool, and a square torque wrench. With the use of this improved wrench, there is adequate leverage in the tool to easily service and adjust most fasteners and/or serviceable parts of rifle weapons like the AR15/M4 weapon.

### BRIEF DESCRIPTION OF THE DRAWINGS

In the accompanying drawings:

FIG. 1 is a perspective view of a first embodiment of a wrench tool embodying the present invention;

FIG. 2 is a front elevational view of the first embodiment of the wrench tool embodying the present invention;

FIG. 3 is a rear elevational view of the first embodiment of the wrench tool embodying the present invention;

FIG. 4 is a right side elevational view of the first, second and third embodiments of the present invention, all of which appear the same;

FIG. 5 is the left side elevational view of the first, second, and third embodiments of the present invention, all of which appear the same;

FIG. 6 is the top plan view of the first, second, and third embodiments of the present invention, all of which appear the same;

FIG. 7 is the bottom plan view of the first, second, and third embodiments of the present invention, all of which appear the same;

FIG. 8 is a front elevational view of a second embodiment of the present invention;

FIG. 9 is a rear elevational view of the second embodiment of the present invention;

FIG. 10 is a front elevational view of a third embodiment of the present invention;

FIG. 11 is a rear elevational view of the third embodiment of the present invention; and

FIG. 12 is a schematic of a typical rifle like the AR15/M4 rifle which shows the various fasters and devices which must be serviced, by being loosened, tightened and/or adjusted using the improved wrench embodying the present invention.

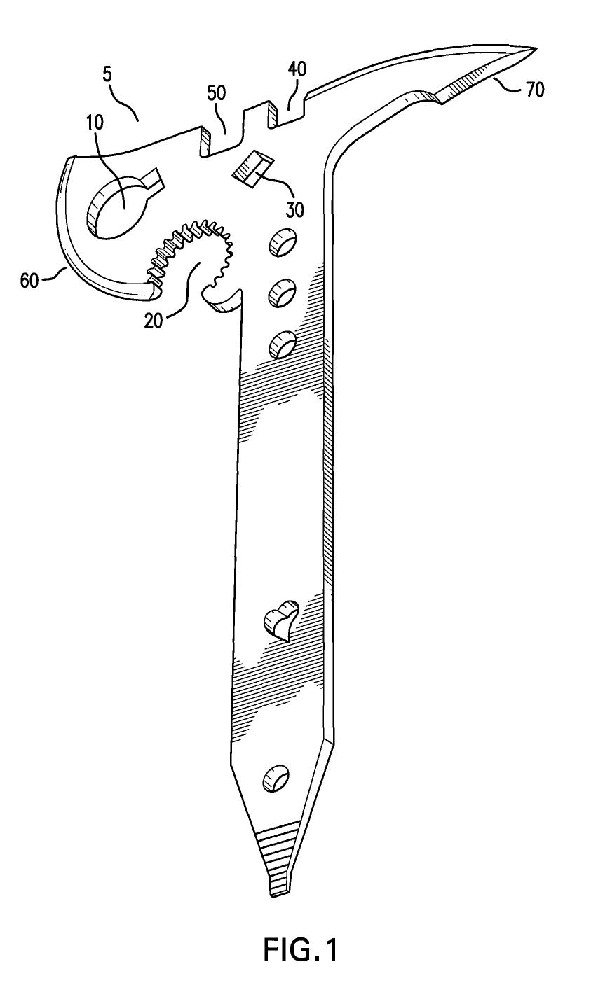

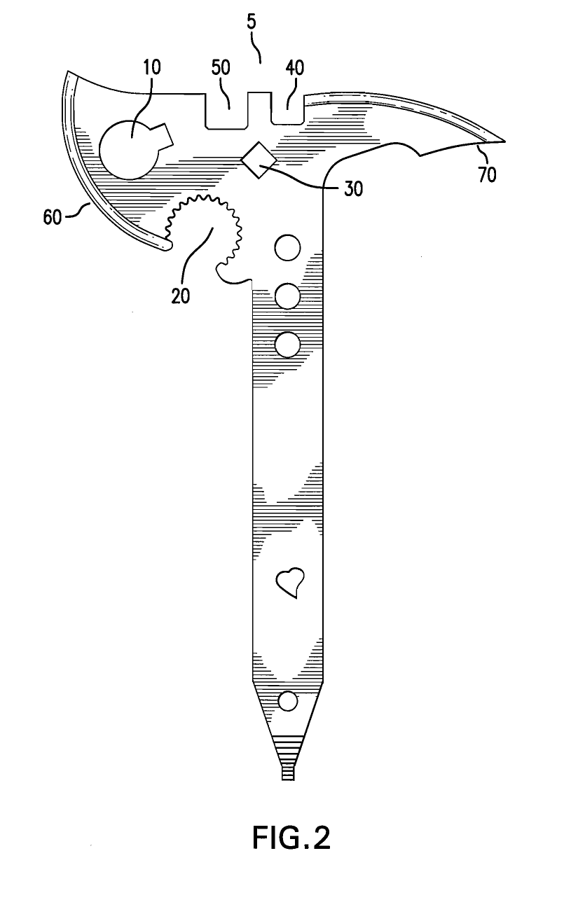

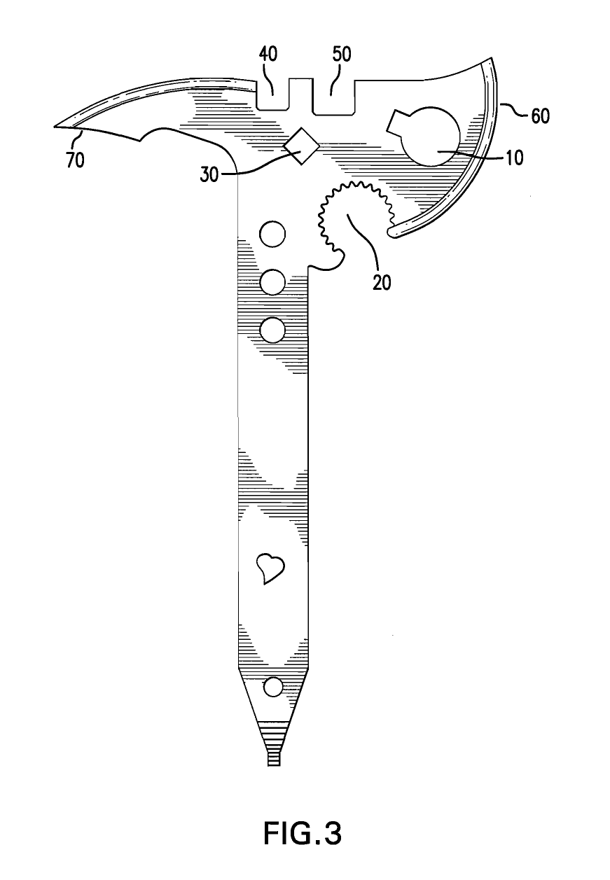

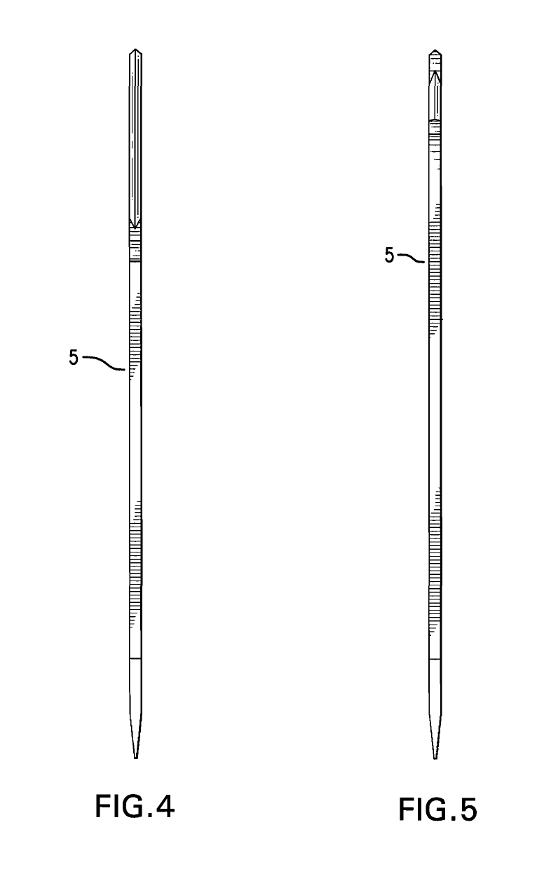

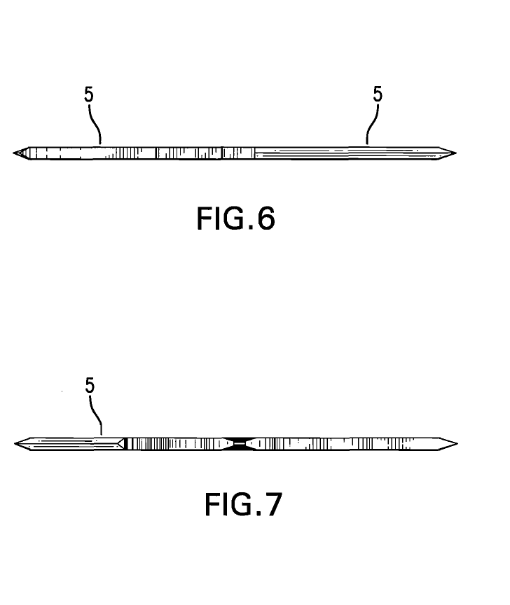

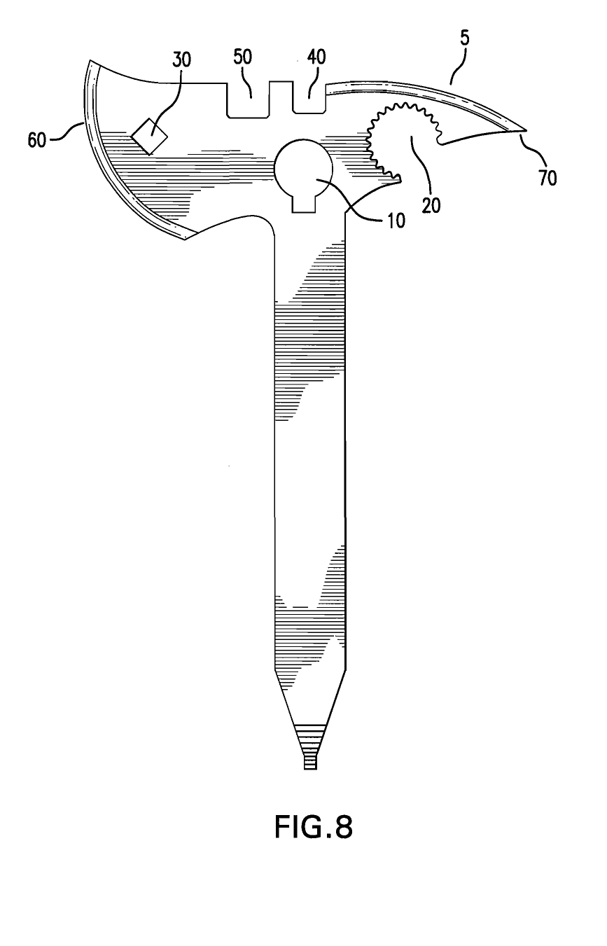

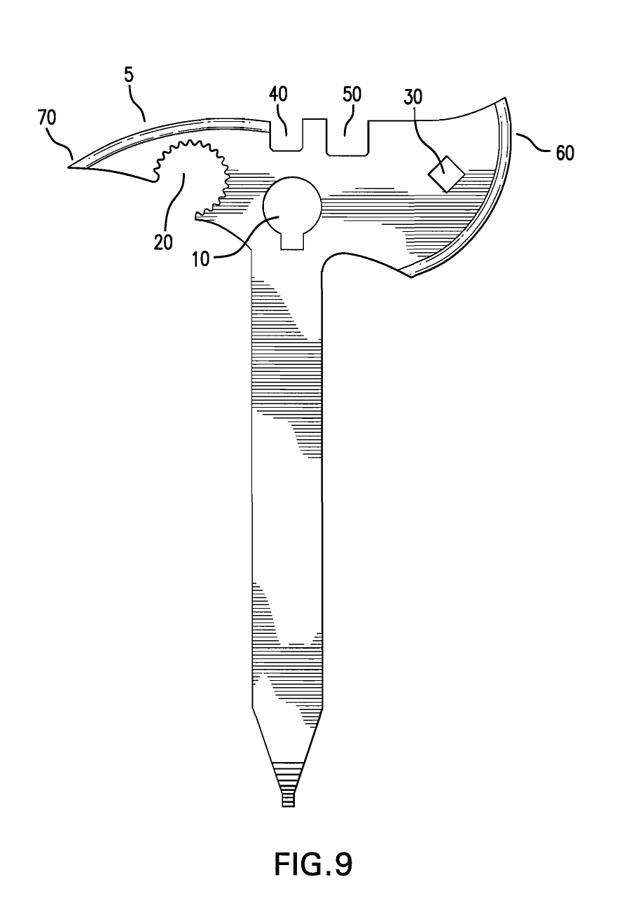

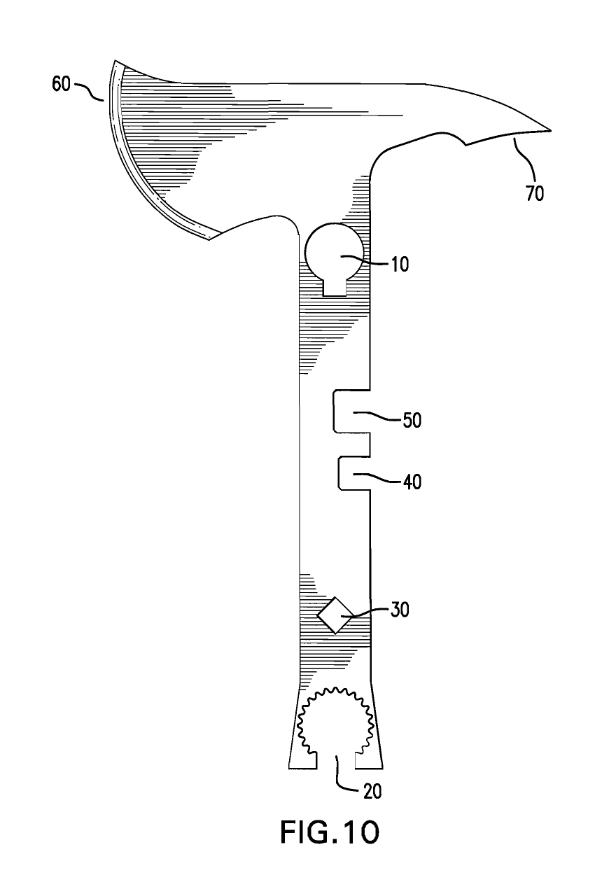

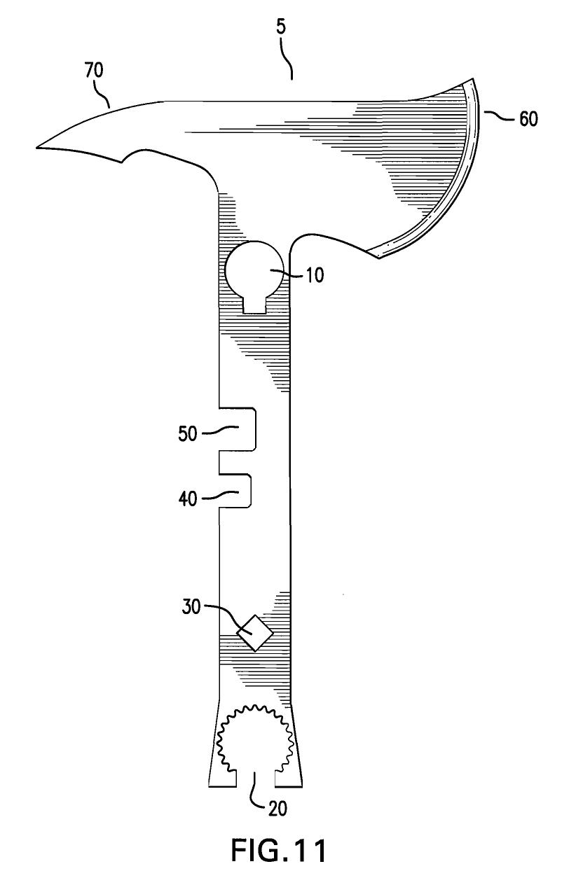

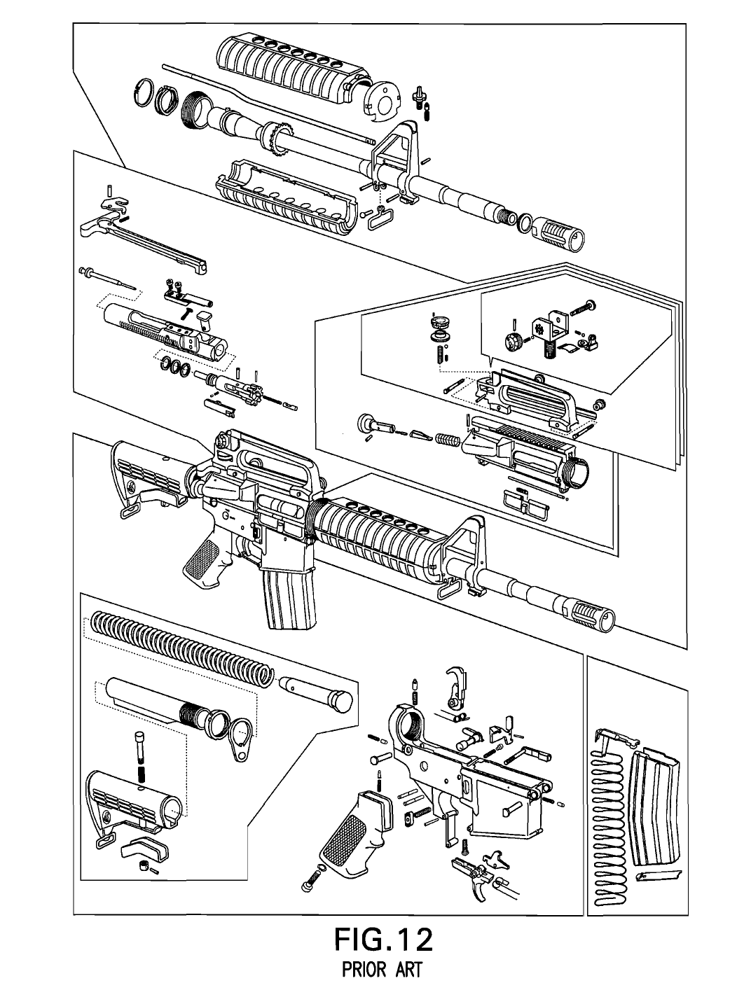

### DETAILED DESCRIPTION OF THE INVENTION

The improved wrench 5 preferably is formed from a piece of approximately 0.25 inch high carbon steel is cut with one or more apertures to create following tools corresponding to a firearm weapon, said tools embodying the invention disclosed in this application. Such tools may consist of the following species:
1. Tool for collapsible stock 10;
2. Tool for a barrel nut 20;
3. Tool for a square torque wrench 30;
4. A Slot for a fixed stock 40;
5. A slot for flash hider 50;
6. A hatchet-like cutting tool 60; and,
7. A pick-like cutting tool 70.

In each instance, each embodiment of the invention enables a user to get leverage for servicing the weapon when it is most needed, namely, when servicing is required for the barrel bolt, the collapsible stock, and/or a square device requiring a torque wrench. Similarly, the other tools are also have corresponding shaped like those on fasteners or other parts of the weapon to maximize effectiveness of the tool.

While embodiments of the invention are shown in considerable detail, it should be understood that various modifications in the size, shapes and locations of the apertures on the wrench may be made to correspond with the size, shapes and locations of the fasteners and devices requiring service on the appropriate weapon. It is not desired that the invention should be limited, except as provided in the accompanying claims.

1. A tool for servicing a firearm having fasteners and elements requiring servicing, said tool comprising
a rigid body having a head and
a shaft of greater length than said head angularly disposed from said head,
said shaft being formed to act as a lever for applying force to said head, and
aperture means in said head defining one or more wrench connections corresponding to one or more fasteners and serviceable elements in said firearm.

2. The tool recited in claim 1, wherein said shaft is connected to said head medially of said head.

3. The tool recited in claim 1, wherein said tool is fabricated in one piece.

4. The tool recited in claim 3, wherein said body consists of tool steel.

5. The tool recited in claim 1, wherein an edge of said head comprises a blade.

6. The tool recited in claim 5, wherein said blade is situated on an edge of said head remote from said shaft.

7. The tool recited in claim 1, wherein said aperture means consists of multiple wrench connections.

8. The tool recited in claim 7, wherein one of said aperture means wrench connections comprises a bayonet gripping device corresponding to an element in said firearm.

9. The tool recite din claim 7, wherein one of said aperture means wrench connections comprises a gear-like socket for receiving a corresponding element in said firearm.

10. The tool recited in claim 7, wherein one of said aperture means wrench connections has a rectilinear shape for receiving a corresponding element in said firearm.

11. The tool recited in claim 7, wherein said head carries slots for receiving corresponding elements in said firearm.

12. The tool recited in claim 1, wherein the end of said shaft remote from said head is configured like a screw driver.

13. A tool for servicing a firearm, said tool comprising
a rigid body having a T-shaped configuration, said body
having a head and a shaft of greater length than said head extending medially from said head,
said head having an ergonomical shape for lever-like manipulation of said shaft, and
aperture means in said shaft defining one or more wrench connections corresponding to one or more fasteners and elements in said firearm.

14. The tool recited in claim 13, wherein said aperture means comprises multiple apertures, each for receiving fasteners and elements of varying shapes and sizes in said firearm.

15. The tool recited in claim 13, wherein said head comprises a hatchet-like cutting tool.

16. The tool recited in claim 13, wherein said tool apertures correspond to fasteners and elements on a AR15/M4 firearm.
